(19) United States
(12) Patent Application Publication
(10) Pub. No.: US 2016/0097182 A1
(43) Pub. Date: Apr. 7, 2016

(54) Anchored Landscaping Device

(71) Applicant: Clayton Golden, Martinez, CA (US)

(72) Inventor: Clayton Golden, Martinez, CA (US)

(21) Appl. No.: 14/504,821

(22) Filed: Oct. 2, 2014

(51) Int. Cl. E02D 31/10; E02D 17/20; A01G 13/00; E02D 31/02

(52) U.S. Cl. CPC E02D 31/10; E02D 31/025; E02D 17/202; A01G 13/0293; A01G 13/0268; E02D 2300/009; E02D 2300/0075

(57) ABSTRACT

An anchored landscaping device facilitates installation of an aggregate material landscaping element and anchors the landscaping element to prevent scattering of the aggregate material. The device includes an anchoring layer constructed of a flexible material. The anchoring layer has a top surface and a perimeter edge. An aggregate landscaping material comprises a plurality of individual elements. Each of the individual elements of the aggregate landscaping material is coupled to the top surface of the anchoring layer wherein each individual element is secured in a fixed position on the top surface of the anchoring layer.

### BACKGROUND OF THE DISCLOSURE

### Field of the Disclosure

The disclosure relates to landscaping devices and more particularly pertains to a new landscaping device for facilitating installation of an aggregate material landscaping element and anchoring the landscaping element to prevent scattering of the aggregate material.

### SUMMARY OF THE DISCLOSURE

An embodiment of the disclosure meets the needs presented above by generally comprising an anchoring layer constructed of a flexible material. The anchoring layer has a top surface and a perimeter edge. An aggregate landscaping material comprises a plurality of individual elements. Each of the individual elements of the aggregate landscaping material is coupled to the top surface of the anchoring layer wherein each individual element is secured in a fixed position on the top surface of the anchoring layer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a anchored landscaping device according to an embodiment of the disclosure.

FIG. 2 is a side view of an embodiment of the disclosure.

FIG. 3 is a top view of an embodiment of the disclosure.

FIG. 4 is a cross-sectional view of an embodiment of the disclosure taken along line 4-4 of FIG. 3.

FIG. 5 is a top front side perspective view of an embodiment of the disclosure in use.

### DESCRIPTION OF THE PREFERRED EMBODIMENT

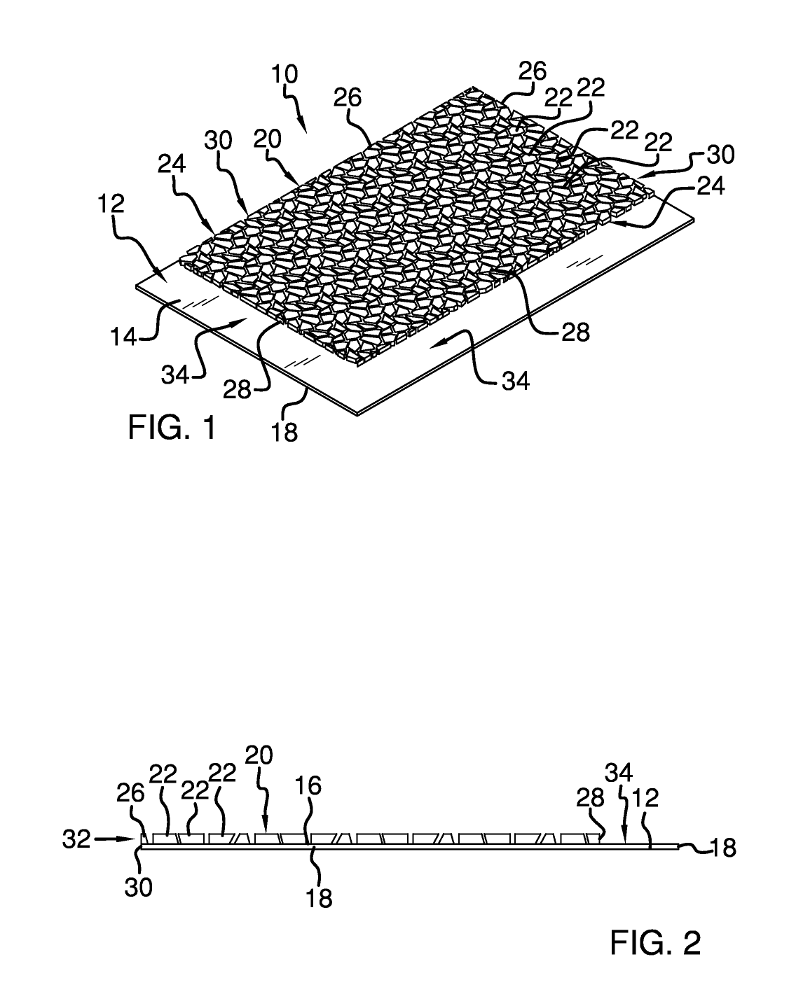

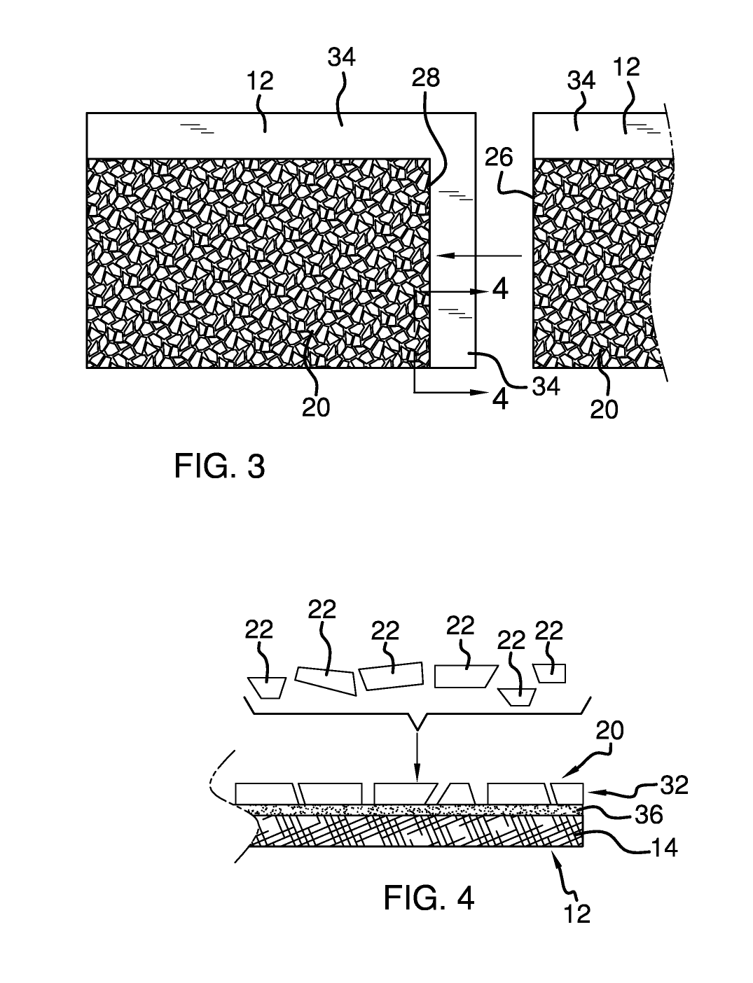

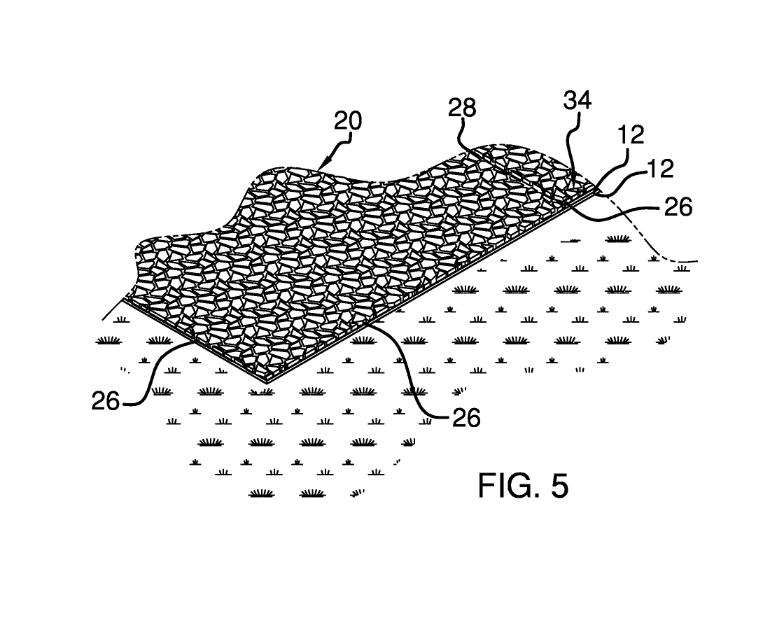

With reference now to the drawings, and in particular to FIGS. 1 through 5 thereof, a new landscaping device embodying the principles and concepts of an embodiment of the disclosure and generally designated by the reference numeral 10 will be described.

As best illustrated in FIGS. 1 through 5, the anchored landscaping device 10 generally comprises an anchoring layer 12 constructed of a flexible material 14. The anchoring layer 12 has a top surface 16 and a perimeter edge 18. The perimeter edge 18 may be a rectangle. An aggregate landscaping material 20 comprises a plurality of individual elements 22 generically represented in the drawing figures. The aggregate landscaping material 20 may be bark which is natural or synthetic and having the appearance of typical conventional landscaping material. Each of the individual elements 22 of the aggregate landscaping material 20 is coupled to the top surface 16 of the anchoring layer 12 wherein each individual element 22 is secured in a fixed position on the top surface 16 of the anchoring layer 12. The aggregate landscaping material 20 is arranged into a single layer 32 on the anchoring layer 12 to define a peripheral edge 24. The peripheral edge 24 comprises a pair of outer sections 26 and a pair of inner sections 28. Each of the outer sections 26 is aligned along an associated side 30 of the perimeter edge 18 of the anchoring layer 12. Each of the inner sections 28 is inset from the perimeter edge 18 of the anchoring layer 12 defining an exposed portion 34 of the top surface 16 of the anchoring layer 12 between the inner sections 28 and the perimeter edge 18 of the anchoring layer 12. The exposed portion 34 may form an L-shape as each of the inner sections 28 is substantially straight, the inner sections 28 are perpendicular, each of the outer sections 26 is substantially straight, and the outer sections 26 are perpendicular. A layer of adhesive 36 couples the aggregate landscaping material 20 to the top surface 16 of the anchoring layer 12 such that the aggregate landscaping material 20 gives a natural randomly distributed appearance to the same material being loosely positioned on the ground.

In use, the individual elements 22 of the aggregate landscaping material 20 cover the top surface of the anchoring layer 12 allowing for use of a single piece of the anchoring layer 12 to be positioned as desired where aggregate landscaping may be wanted. Additional pieces of the device 10 may be positioned with one of the inner sections 28 being abutted by an outer section 26 whereby the anchoring layer 12 having the outer section 26 overlaps and holds down at least part of the exposed portion 34 of the anchoring layer 12 having the inner section 28. The anchoring layer 12 may be cut to a desired shape and the exposed portion 34 not overlapped may be trimmed away to provide a clean landscaped look which is durable as the individual elements 22 of the aggregate landscaping material 20 will remain fixed on the respective anchoring layer 12 to which it is coupled.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An anchored landscaping device comprising:
an anchoring layer, said anchoring layer being constructed of a flexible material, said anchoring layer having a top surface and a perimeter edge; and
an aggregate landscaping material comprising a plurality of individual elements, each of said individual elements of said aggregate landscaping material being coupled to said top surface of said anchoring layer wherein each individual element is secured in a fixed position on said top surface of said anchoring layer, said aggregate landscaping material being arranged to define a peripheral edge, said peripheral edge comprising a pair of outer sections and a pair of inner sections, each of said outer sections being aligned along an associated side of said perimeter edge of said anchoring layer, each of said inner section being inset from said perimeter edge of said anchoring layer defining an exposed portion of said top surface of said anchoring layer between said inner sections and said perimeter edge of said anchoring layer.

2. (canceled)

3. (canceled)

4. The device of claim 1, further comprising each of said inner sections being straight.

5. The device of claim 4, further comprising said inner sections being perpendicular.

6. The device of claim 1, further comprising each of said outer sections being straight.

7. The device of claim 6, further comprising said outer sections being perpendicular.

8. The device of claim 1, further comprising said aggregate landscaping material being bark.

9. The device of claim 1, further comprising a layer of adhesive coupling said aggregate landscaping material to said top surface of said anchoring layer.

10. An anchored landscaping device comprising:
an anchoring layer, said anchoring layer being constructed of a flexible material, said anchoring layer having a top surface and a perimeter edge;
an aggregate landscaping material comprising a plurality of individual elements, said aggregate landscaping material being bark, each of said individual elements of said aggregate landscaping material being coupled to said top surface of said anchoring layer wherein each individual element is secured in a fixed position on said top surface of said anchoring layer, said aggregate landscaping material being arranged to define a peripheral edge, said peripheral edge comprising a pair of outer sections and a pair of inner sections, each of said outer sections being aligned along an associated side of said perimeter edge of said anchoring layer, each of said inner section being inset from said perimeter edge of said anchoring layer defining an exposed portion of said top surface of said anchoring layer between said inner sections and said perimeter edge of said anchoring layer, each of said inner sections being straight, said inner sections being perpendicular, each of said outer sections being straight, said outer sections being perpendicular; and
a layer of adhesive coupling said aggregate landscaping material to said top surface of said anchoring layer.
